(19) United States
(12) Patent Application Publication
(10) Pub. No.: US 2026/0045809 A1
(43) Pub. Date: Feb. 12, 2026

(54) CHARGING MODULE AND BATTERY CHARGING CASE

(71) Applicant: Shenzhen Obuy Technology Co., Ltd, Shenzhen (CN)

(72) Inventors: QI YUAN, Shenzhen (CN); OU YANG, Shenzhen (CN); MANCHUN CAI, Shenzhen (CN); ZIYANG ZHOU, Shenzhen (CN)

(21) Appl. No.: 19/016,004

(22) Filed: Jan. 10, 2025

(30) Foreign Application Priority Data
Aug. 7, 2024 (CN) 202411075378.8

(51) Int. Cl. H02J 7/00; H01M 10/46; H01M 10/54

(52) U.S. Cl. CPC H02J 7/0042; H01M 10/46; H01M 10/54

(57) ABSTRACT

The present application discloses a charging module and a battery charging case, the charging module includes a charging compartment and a transfer component. The charging compartment includes a compartment body and a second bracket; the first discharging side of the second bracket includes a first opening for the fully charged batteries to flow through, and the second discharging side of the second bracket includes a second opening for the waste batteries to flow through; the transfer component is installed on the second bracket and located between the first discharging side of the second bracket and the second discharging side of the second bracket. The transfer component switches between the first and second transfer states, such that the fully charged batteries are transferred through the first opening in the first transfer state, and the waste batteries are transferred through the second opening in the second transfer state.

### CROSS-REFERENCE TO RELATED APPLICATIONS

This application claims priority to Chinese Patent Application No. 202411075378.8, filed on Aug. 7, 2024, which is hereby incorporated by reference in its entirety.

### TECHNICAL FIELD

The present application relates to the field of battery charging technology, particularly to a charging module and a battery charging case.

### BACKGROUND

The battery charging case includes a charging module for charging the batteries to be charged. Understandably, the batteries to be charged include, but are not limited to, the batteries to be charged that meet the model requirements and the batteries to be charged that do not meet the model requirements; the batteries to be charged that meet the model requirements include the batteries to be charged that meet the model requirements and are not damaged and those that meet the model requirements and have been damaged. The charging component of charging module can only charge the batteries to be charged that meet the model requirements and are not damaged

However, the charging modules in related technologies are too structurally simple to transfer to corresponding areas the fully charged batteries, the batteries to be charged that do not meet the model requirements, and the batteries to be charged that meet the model requirements but have been damaged. Therefore, how to enable the charging module to effectively transfer to corresponding areas the fully charged batteries, the batteries to be charged that do not meet the model requirements, and the batteries to be charged that meet the model requirements but have been damaged has become an urgent problem to be solved.

### SUMMARY

The present embodiment provides a charging module and a battery charging case, which can solve the problem that the charging module in related technologies cannot effectively transfer the fully charged batteries, the batteries to be charged that do not meet the model requirements, and the batteries to be charged that meet the model requirements but have been damaged.

In the first aspect, the embodiment of the present application provides a charging module; the charging module is used for the battery charging case and used to charge the batteries to be charged, and the charging module comprises a charging compartment and a transfer component; the charging compartment comprises a compartment body and a second bracket, and the second bracket is installed in the chamber of the compartment body and has a first discharging side and a second discharging side that are arranged along the width direction of battery charging case; the first discharging side of the second bracket has a first opening for fully charged batteries to flow through, and the second discharging side of the second bracket has a second opening for waste batteries to flow through; the transfer component is installed on the second bracket and located between the first discharging side of the second bracket and the second discharging side of the second bracket; the transfer component has a first transfer state and a second transfer state, and switches between the first and second transfer states, such that fully charged batteries are transferred through the first opening in the first transfer state, and waste batteries are transferred through the second opening in the second transfer state.

In the second aspect, the embodiment of the present application provides a battery charging case; the battery charging case comprises a feeding module, a discharging module, and the aforementioned charging module, and the feeding module is used to accommodate the batteries to be charged, while the discharging module is used to accommodate fully charged batteries; the discharging port of feeding compartment of feeding module is connected to the feeding port of compartment body, and the discharging port of charging module is connected to the feeding port of discharging compartment of discharging module.

Based on the charging module and battery charging case in the embodiment of the present application, a transfer component that can switch between a first transfer state and a second transfer state is designed; the transfer component in the first transfer state can automatically transfer fully charged batteries to the first discharging side of the second bracket, so that fully charged batteries can flow through the first opening of the second bracket; the transfer component in the second transfer state can automatically transfer waste batteries to the second discharging side of the second bracket, so that waste batteries can flow through the second opening of the second bracket, and therefore the charging module can automatically transfer fully charged batteries and waste batteries.

### BRIEF DESCRIPTION OF DRAWINGS

In order to provide a clearer explanation of the technical solution of the embodiments of the present application, the accompanying drawings required for the description of the embodiments will be briefly introduced below. Obviously, the accompanying drawings described below are some embodiments of the present invention, and those of ordinary skill in the art can also obtain other drawings based on these ones without creative labor.

FIG. 1 is a structure diagram of a cross-section of a charging module in one embodiment of the present application;

FIG. 2 is a structure diagram of transfer component installed on the second bracket in one embodiment of the present application;

FIG. 3 is a structure diagram of the waste bin in FIG. 2 when moving relative to the base to an extended state;

FIG. 4 is a structure diagram of FIG. 3 from another perspective;

FIG. 5 is an exploded structure diagram of transfer component in one embodiment of the present application;

FIG. 6 is a structure diagram of waste bin in one embodiment of the present application when moving relative to the base to an extended state;

FIG. 7 is a structure diagram of a battery charging case in one embodiment of the present application.

Reference Numerals in the attached drawings: 1. Battery charging case; XX′, length direction; YY′, width direction; ZZ′, height direction; 10. Feeding module; 11. Feeding compartment; 20. Charging module; 21. Charging compartment; 211. Compartment body; 211b. Waste discharging port; 213. Second bracket; 213b. First opening; 213c. Second opening; 51. Base; 51a. Discharging port of the base; 52. waste bin; 52c. Guide surface; 30. Discharging module; 31. Discharging compartment; 41. Partition component; 411. Partition plate; 411a, Partition port; 42. Transfer component; 421. Transfer frame body; 422. Transfer unit; 422a. Driving pulley; 422b. Driven pulley; 422c. Conveyor belt; 422d. Rotating shaft; 422e. Another rotating shaft; 423. Fourth motor; 43. Limit component.

### DESCRIPTION OF EMBODIMENTS

In order to make the purpose, technical solution, and advantages of the present application clearer and more understandable, further detailed explanations of the present application will be provided in conjunction with the accompanying drawings and embodiments. It should be understood that the specific embodiments described herein are only used to explain, rather than limit the present application.

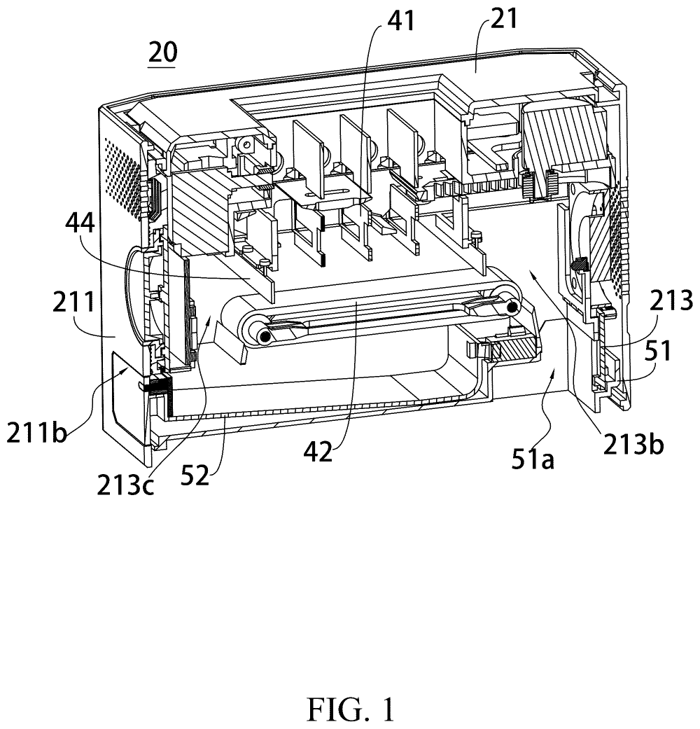

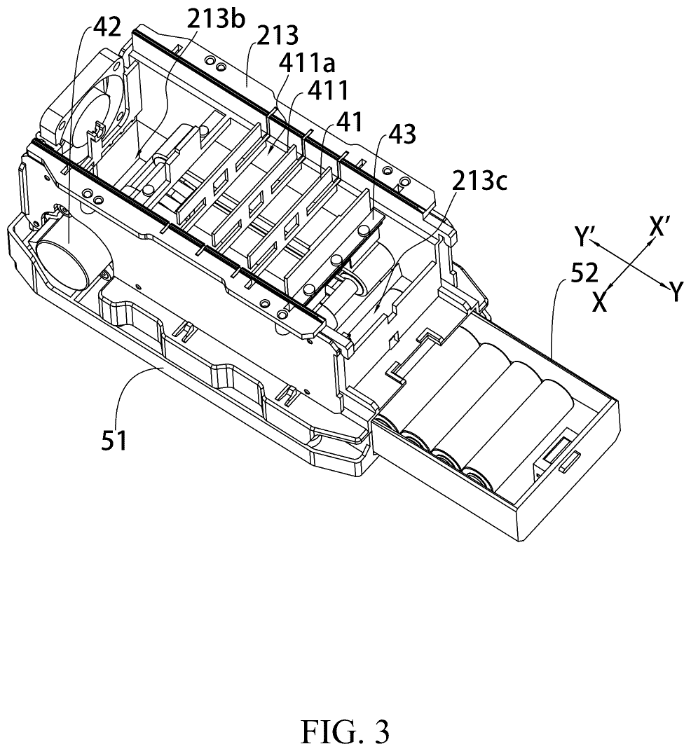

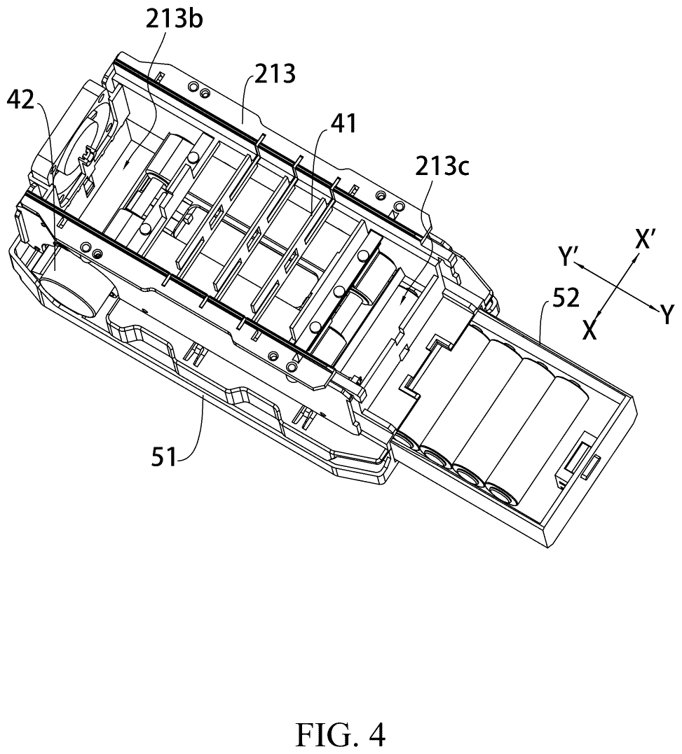

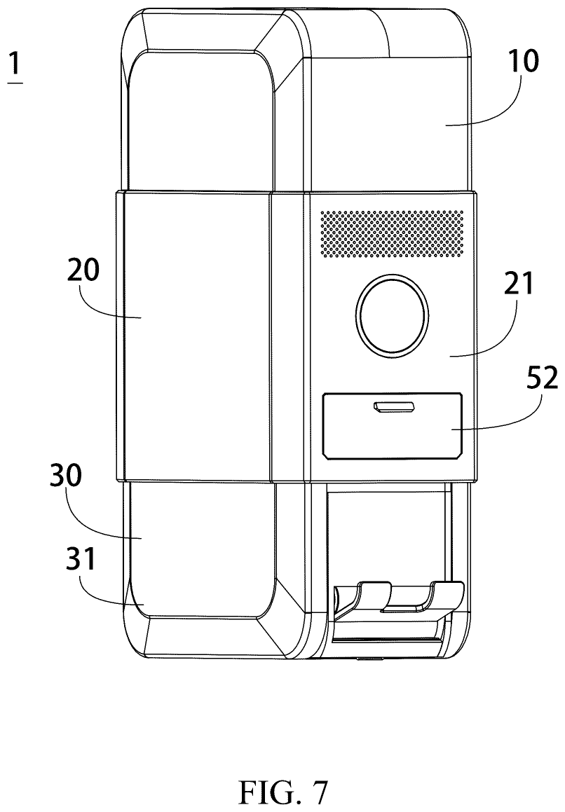

As shown in FIG. 1-4, in the first aspect, the present application proposes a charging module 20 that is used for a battery charging case 1 (as shown in FIG. 7) to automatically transfer fully charged batteries and waste batteries.

The charging module 20 is used for the battery charging case 1, and the charging module 20 comprises a charging compartment 21 and a transfer component 42; the charging compartment 21 comprises a compartment body 211 and a second bracket 213, and the second bracket 213 is installed in the chamber of compartment body 211 and has a first discharging side and a second discharging side that are arranged along the width direction YY′ of battery charging case 1; the first discharging side of the second bracket 213 has a first opening 213b for fully charged batteries to flow through, and the second discharging side of the second bracket 213 has a second opening 213c for waste batteries to flow through; the transfer component 42 is installed on the second bracket 213 and located between the first discharging side of the second bracket 213 and the second discharging side of the second bracket 213. The transfer component 42 has a first transfer state and a second transfer state, and switches between the first and second transfer states, such that fully charged batteries are transferred by the transfer component 42 to the first opening 213b in the first transfer state, and waste batteries are transferred by the transfer component 42 to the second opening 213c in the second transfer state.

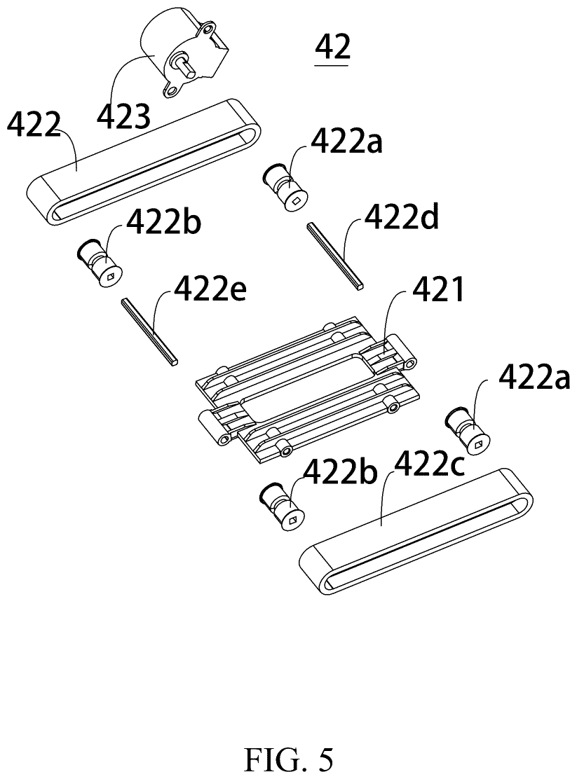

The specific structure of charging module 20 will be described below in conjunction with FIG. 1-6.

Charging module 20 is used to charge the batteries to be charged. Understandably, the batteries to be charged include, but are not limited to, the batteries to be charged that meet the model requirements and the batteries to be charged that do not meet the model requirements; the batteries to be charged that meet the model requirements include the batteries to be charged that meet the model requirements and are not damaged and those that meet the model requirements and have been damaged. The charging component (not shown in the drawing) of charging module 20 can only charge the batteries to be charged that meet the model requirements and are not damaged, and the charging component of charging module 20 cannot charge the batteries to be charged that meet the model requirements and have been damaged, as well as the batteries to be charged that do not meet the model requirements. For example, taking the AA and AAA batteries as examples, the AA batteries, larger ones, are defined as the batteries to be charged that meet the model requirements, while the AAA batteries, smaller ones, are defined as the batteries to be charged that do not meet the model requirements,

As shown in FIG. 1-4, the charging module 20 comprises a charging compartment 21 and a transfer component 42.

On the one hand, as the outer shell of charging module 20, the charging compartment 21 comprises a compartment body 211 and, for example, the outer contour shape of compartment body 211 can be, but is not limited to, a rectangular prism or a cylindrical prism; the specific preparation material of the compartment body 211, can be, but is not limited to, plastic cement or one of the plastics. Designing the preparation material of compartment body 211 as plastic cement or plastics can effectively reduce the cost of battery charging case 1.

On the other hand, as the bracket of charging module 20, the charging compartment 21 also comprises a first bracket 212; the specific preparation material of the first bracket 212 can be, but is not limited to, plastic cement or one of the plastics.

The second bracket 213 is installed in the chamber of the compartment body 211, the second bracket 213 and the compartment body 211 can be specifically connected as follows, for example, when the second bracket 213 is detachably connected to the compartment body 211, the second bracket 213 can be fixedly connected to the compartment body 211 through at least one screw connection, snap-in connection, or plug-in connection and, for example, when the second bracket 213 is non detachably connected to the compartment body 211, the second bracket 213 can be fixedly connected to the compartment body 211 through, but are not limited to, adhesive bonding.

The second bracket 213 has a first discharging side and a second discharging side that are arranged along the width direction YY′ of battery charging case 1. “The first discharging side of second bracket 213” is understood as the side of the second bracket 213 through which fully charged batteries flow out of the second bracket 213; “the second discharging side of second bracket 213” is understood as the side of the second bracket 213 through which waste batteries flow out of the second bracket 213. The waste batteries include, but are not limited to, the batteries to be charged that meet the model requirements and have been damaged and those that do not meet the model requirements.

The first discharging side of the second bracket 213 has a first opening 213b for fully charged batteries to flow through, and the second discharging side of the second bracket 213 has a second opening 213c for waste batteries to flow through. “The first opening 213b” is understood as the opening of the second bracket 213 through which fully charged batteries flow; “the second opening 213c” is understood as the opening of the second bracket 213 through which waste batteries flow.

As shown in FIG. 1-4, transfer component 42, as a structural member of charging module, is used to transfer fully charged batteries to the first opening 213b and waste batteries to the second opening 213c.

The transfer component 42 is installed on the second bracket 213 and located between the first discharging side of the second bracket 213 and the second discharging side of the second bracket 213, such that fully charged batteries are transferred by the transfer component 42 to the first opening 213b and waste batteries are transferred by the transfer component 42 to the second opening 213c.

The transfer component 42 has a first transfer state and a second transfer state, and switches between the first and second transfer states, such that fully charged batteries are transferred by the transfer component 42 to the first opening in the first transfer state, and waste batteries are transferred by the transfer component 42 to the second opening in the second transfer state.

Based on the charging module 20 in the embodiment of the present application, a transfer component 42 is designed to switch between the first transfer state and the second transfer state, the transfer component 42 in the first transfer state can automatically transfer fully charged batteries to the first discharging side of the second bracket 213, so that fully charged batteries can flow through the first opening 213b of the second bracket 213; the transfer component 42 in the second transfer state can automatically transfer waste batteries to the second discharging side of the second bracket 213, so that waste batteries can flow through the second opening 213c of the second bracket 213, and therefore the charging module 20 can automatically transfer fully charged batteries and waste batteries.

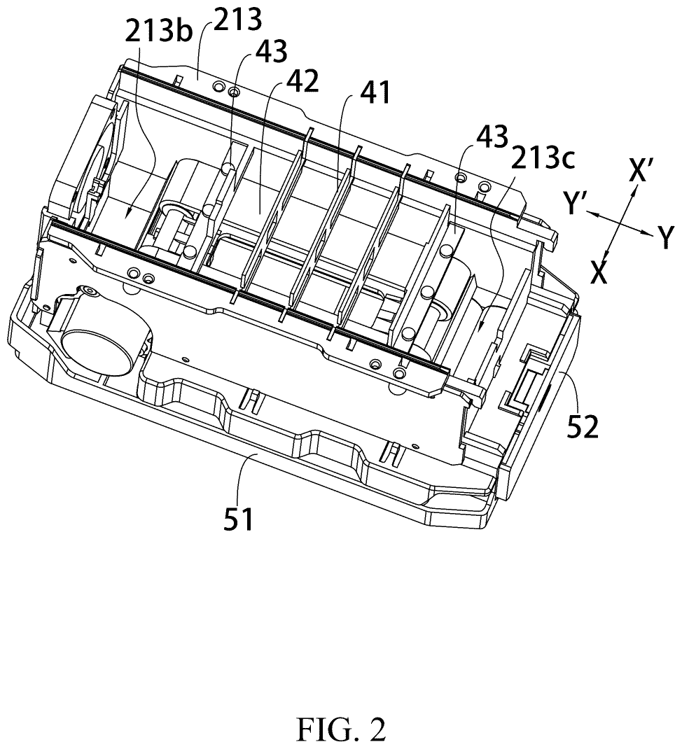

As shown in FIG. 2-5, the charging module 20 also includes a control component that is installed on the second bracket 213; the control component is electrically connected to the transfer component 42 so that the transfer component 42 can switch between the first transfer state and the second transfer state.

Here, the control component serves as a control center for charging module 20, and designers can make reasonable designs according to actual needs and, for example, the control component includes a microprocessor unit that is electrically connected to the classification component (specifically the fourth motor 423 described below). The control component can control the transfer component 42 to switch between the first transfer state and the second transfer state mentioned above.

It should be noted that the charging module 20 also includes a screening component (not shown in the drawing) and a charging component (not shown in the drawing); the screening component is used for effective screening of batteries to be charged; the charging component is used to effectively charge the batteries to be charged that meet the model specifications; the control component is used to switch the transfer component 42 between the first transfer state and the second transfer state based on the magnitude of the charging current. When the batteries to be charged flow out of the discharging port of feeding compartment 11 of feeding module 10 and enter the chamber of compartment body 211 through the feeding port of compartment body 211, the screening component will first effectively screen the batteries to be charged, and screen the batteries to be charged that do not meet the model requirements which will fall onto the transfer component 42. The control component then controls the transfer component 42 to be in the second transfer state to transfer the batteries to be charged that do not meet the model requirements to the second opening 213c, the screened batteries to be charged that do not meet the model requirements will flow through the second opening 213c of the second bracket 213 and into the chamber of waste bin 52 from the feeding port of (as described below) of waste bin 52. After the batteries to be charged that do not meet the model requirements are screened, the charging component begins to charge the batteries to be charged that meet the model requirements, and the control component can, based on the magnitude of charging current, determine whether the batteries to be charged that meet the model requirements are damaged ones that cannot be charged, or undamaged ones that can be charged; for example, if the control component determines, based on the magnitude of charging current, that the batteries to be charged that meet the model requirements are damaged batteries that cannot be charged, the damaged batteries to be charged that meet model requirements fall onto the transfer component 42, then the control component controls the transfer component 42 to be in the second transfer state to transfer the damaged batteries to be charged that meet model requirements to the second opening 213c. Then the damaged batteries to be charged that meet model requirements flow through the second opening 213c of the second bracket 213 and enter the chamber of waste bin 52 from the feeding port of waste bin 52 (as described below); for example, if the control component determines, based on the magnitude of charging current, that the batteries to be charged that meet model requirements are undamaged batteries that can be charged, the batteries to be charged that meet model requirements but are damaged become fully charged batteries after being charged by the charging component, and then fall onto the transfer component 42, then the control component controls transfer component 42 to be in the first transfer state to transfer fully charged batteries to the first opening 213b, and the fully charged batteries flow through the first opening 213b of the second bracket 213, and flow out of the chamber of compartment body 211 through the discharging port of the base 51 (as described below), and then enter the chamber of discharging compartment 31 from the discharging port of discharging compartment 31 of discharging module 30 (as described below).

Furthermore, as shown in FIG. 2-5, the transfer component 42 comprises a transfer frame body 421, a transfer unit 422, and a fourth motor 423; the transfer frame body 421 is installed on the second bracket 213 and located between the first discharging side of the second bracket 213 and the second discharging side of the second bracket 213; the transfer unit 422 is installed on the transfer frame body 421, and is used to carry and transfer fully charged batteries as well as waste batteries; the fourth motor 423 is installed on the second bracket 213 and is electrically connected to the control component, and the drive shaft of the fourth motor 423 is connected to the transfer unit 422. In the first transfer state, the control component controls the fourth motor 423 to drive the transfer unit 422 to move, in order to transfer the fully charged batteries on the transfer unit 422 to the first opening 213b; in the second transfer state, the control component controls the fourth motor 423 to drive the transfer unit 422 to move, in order to transfer the waste batteries on the transfer unit 422 to the second opening 213c.

The transfer frame body 421, as a frame body of transfer component 42, is used to support the transfer unit 422. The transfer frame body 421 can be connected to the second bracket 213 through the following specific means, for example, the transfer frame body 421 can be detachably connected to the second bracket 213 through at least one screw connection, snap-in connection, or plug-in connection and, for example, the transfer frame body 421 can be non detachably connected to the second bracket 213 through, but are not limited to, adhesive bonding.

The transfer unit 422, as a structural member of the transfer component 42, is used to carry and transport fully charged batteries and waste batteries. The specific manifestation of the transfer unit 422 will be introduced below.

The fourth motor 423, as a power source of transfer component 42, is used to drive transfer unit 422 to move. The fourth motor 423 can be detachably connected to the second bracket 213 through, but are not limited to, at least one screw connection, snap-in connection, or plug-in connection and, for example, the fourth motor 423 can be non detachably connected to the second bracket 213 through, but are not limited to, adhesive bonding.

The fourth motor 423 is designed and in the first transfer state, the control component controls the fourth motor 423 to drive the transfer unit 422 to move and transfer the fully charged batteries to the first opening 213b, then the fully charged batteries can flow through the first opening 213b of the second bracket 213; the fourth motor 423 is designed and in the second transfer state, the control component controls the fourth motor 423 to drive the transfer unit 422 to move and transfer the waste batteries to the second opening 213c, then the waste batteries can flow through the second opening 213c of the second bracket 213.

Furthermore, as shown in FIG. 2-5, the transfer unit 422 includes a driving pulley 422a, a driven pulley 422b, and a conveyor belt 422c; the driving pulley 422a is installed on one end of the transfer frame body 421 along the width direction YY′ of battery charging case 1, and is fixedly connected to the driving shaft of the fourth motor 423; the driven pulley 422b is installed on the other end of the transfer bracket along the width direction YY′ of battery charging case 1; the conveyor belt 422c is drivingly connected to the driving pulley 422a and driven pulley 422b and is used to carry fully charged batteries and waste batteries.

There are two driving pulleys 422a, and the two driving pulleys 422a are arranged on both sides of the transfer frame body 421 along the length direction XX′ of battery charging case 1, the two driving pulleys 422a are rotatably connected to the transfer frame body 421 through a rotating shaft 422d. The number of driven pulleys 422b is two, and the two driven pulleys 422b are arranged on both sides of the transfer frame body 421 along the length direction XX′ of battery charging case 1, and the two driven pulleys 422b are rotatably connected to the transfer frame body 421 through another rotating shaft 422e.

The driving pulley 422a can be connected to the fourth motor 423 through the following specific means, for example, the driving pulley 422a can be detachably connected to the fourth motor 423 through at least one screw connection, snap-in connection, or plug-in connection and, for example, the driving pulley 422a can be non detachably connected to the fourth motor 423 through, but is not limited to, adhesive bonding.

The fourth motor 423 is designed and in the first transfer state, the control component controls the fourth motor 423 to drive the driving pulley 422a to rotate, the rotating driving pulley 422a drives the conveyor belt 422c connected hereto to rotate, and the rotating conveyor belt 422c drives the driven pulley 422b connected hereto to rotate, such that the fully charged batteries carried on the conveyor belt 422c can be transferred to the first opening 213b, and the fully charged batteries can pass through the first opening 213b of the second bracket 213. The fourth motor 423 is designed and in the second transfer state described above, the control component controls the fourth motor 423 to drive the driving pulley 422a to rotate, the rotating driving pulley 422a drives the conveyor belt 422c connected hereto to rotate, and the rotating conveyor belt 422c drives the driven pulley 422b connected hereto to rotate, such that the waste batteries carried on the conveyor belt 422c can be transferred to the second opening 213c, and the waste batteries can pass through the second opening 213c of the second bracket 213.

Of course, in other embodiments, the transfer unit may also include two driving gears (not shown in the drawing), two driven gears (not shown in the drawing), and a toothed belt (not shown in the drawing); two driving gears are installed on one end of the transfer frame body 421 along the width direction YY′ of battery charging case 1 and are rotatably connected to the transfer frame body 421 through a rotating shaft 422d, and the driving shaft of the fourth motor 423 is fixedly connected to one of the driving gears; two driven gears are installed on the other end of the transfer frame body 421 along the width direction YY′ of battery charging case 1, and the two driven gears are rotatably connected to the transfer frame body 421 through another rotating shaft 422e; the toothed belt meshes with two driving gears and two driven gears, and is used to carry fully charged batteries and waste batteries.

Furthermore, as shown in FIG. 1-4, the charging module 20 also includes a limit component 43 that is installed on the second bracket 213 and provided near the first discharging side of the second bracket 213 and the second discharging side of the second bracket 213; before the transfer component 42 transfers fully charged or waste batteries, the limit component 43 is used to control the waste batteries to roll through the first opening 213b, relative to the transfer component 42, towards the first discharging side of the second bracket 213, and the limit component 43 is also used to control the fully charged batteries to roll through the first opening 213b, relative to the transfer component 42, towards the second discharging side of the second bracket 213.

Before the transfer component 42 transfers fully charged batteries, and fully charged batteries falling onto the transfer component 42 under its own gravity have a certain kinetic energy, which may cause the fully charged batteries to roll relative to the transfer component 42 towards the second discharging side of the second bracket 213. The limit component 43 is designed, and the limit component 43 has a blocking effect on the fully charged batteries, effectively preventing fully charged batteries from rolling into the second opening 213c of the bracket. Before the transfer component 42 transfers waste batteries, the waste batteries falling onto the transfer component 42 under own gravity have a certain kinetic energy, which may cause waste batteries to roll relative to the transfer component 42 towards the first discharging side of the second bracket 213. The limit component 43 is designed and the limit component 43 has a blocking effect on the waste batteries, effectively preventing fully charged batteries from rolling into the first opening 213b of the bracket.

Specifically, the limit component 43 includes a limit element (not shown in the drawing) and a connector (not shown in the drawing). The limit element is used to generate elastic deformation under external force, and is detachably connected to the second bracket 213 through the connector. The limit element can be, but is not limited to, a limiting plate or a limiting grid. The connector serves as an intermediate connection structure between the limit element and the second bracket 213, and can be, but is not limited to, a screw or a pin; For example, when the connector is a screw, the limit element is detachably connected to the second bracket 213 through locking screws; For example, when the connector is a pin, the limit element is detachably connected to the second bracket 213 through pin insertion. Limit element and connector are designed, the limit element is detachably connected to the second bracket 213 through connectors to facilitate effective replacement of damaged limit element. The limit element is suitable for generating elastic deformation under external force, so that when the transfer component 42 is transferring fully charged batteries, the fully charged batteries come into contact with and press the limit element to cause deformation, forming a larger gap between the limit element and the transfer component 42, then the fully charged batteries can pass through the larger gap formed between the limit element and the transfer component 42 under the action of transfer component 42, and smoothly pass through the first opening 213b of the second bracket 213; Similarly, waste batteries come into contact with and compress limit element to cause deformation, forming a larger gap between the limit element and the transfer component 42, then the waste batteries can pass through the larger gap formed between the limit element and the transfer component 42 under the action of transfer component 42, and smoothly pass through the second opening 213c of the second bracket 213.

It should be noted that a large gap is formed between with the deformed limit element and the transfer component 42 only when the fully charged or waste batteries come into contact with the limit element under the transfer action of the transfer component 42. After the fully charged or waste batteries pass through the limit element, the limit element recovers its elastic deformation, and then the gap formed between the limit element and the transfer component 42 in its natural state is relatively small. Before the transfer component 42 transfers the fully charged or waste batteries, the kinetic energy accumulated by the fully charged or waste batteries under their own gravity is insufficient to cause sufficient deformation of limit element when the fully charged or waste batteries roll into contact with the limit element, and the gap formed between the limit element and the transfer component 42 is too small to allow the fully charged or waste batteries to pass through the limit element.

Furthermore, as shown in FIG. 1-4, the charging module 20 also includes a partition component 41 that is located on the feeding side of the second bracket 213 and connected to the second bracket 213, and the partition component 41 has a partition port 411a corresponding to the transfer component 42, and the partition port 411a has a size adapted to that of a fully charged battery. “The feeding side of the second bracket 213” is understood as the side of the second bracket 213 where the fully charged batteries and waste batteries fall onto the transfer component 42. The size of partition port 411a of partition component 41 is adapted to that of the fully charged battery, indicating that the size of partition port 411a of partition component 41 will not be too large, as long as the size is slightly larger than that of a fully charged battery, and the fully charged battery can smoothly pass through the partition port 411a of the partition component 41. A partition component 41 is designed, and the partition component 41 separates the feeding side of second bracket 213 into a partition port 411a that is adapted to the fully charged battery in size, so that when the fully charged batteries pass through partition port 411a of partition component 41, the partition port 411a of partition component 41 can correct the position of fully charged batteries, and the fully charged batteries falling onto the transfer component 42 are neatly arranged on the transfer component 42. Similarly, the partition port 411a of partition component 41 can also serve as a position correction for waste batteries, and the waste batteries falling onto the transfer component 42 can be neatly arranged on the transfer component 42.

Specifically, the partition component 41 includes a plurality of (two or more) partition plates 411 connected to the second bracket 213. and a plurality of partition plates 411 are disposed at equal intervals along the width direction YY′ of battery charging case 1, and the gap between adjacent two partition plates 411 is used to form the partition port 411a. The partition component 41 is designed as a plurality of partition plates 411 spaced along the width direction YY′ of battery charging case 1, the gap between adjacent partition plates 411 can be used to form the above-mentioned partition port 411a, which has a simple structure and is easy to implement. It should be noted that when fully charged and waste batteries pass through the gap between adjacent partition plates 411 under their own gravity, the fully charged and waste batteries may collide with the partition plate 411 and, in this case, the designed partition plate 411 is made from a material having a high elastic coefficient such as rubber or silicone, such that a good buffering performance is provided for the fully charged and waste batteries, effectively reducing the possibility of damage caused by excessive impact force during the falling process.

The specific connection method between the partition plate 411 and the second bracket 213 can be, but is not limited to, the following embodiments.

As shown in FIG. 1-4, in the first embodiment, multiple partition plates 411 are detachably connected to the second bracket 213 through a snap-in connection and, for example, the two opposing surfaces of the second bracket 213 along the length direction XX′ of battery charging case 1 are provided with multiple pairs of slots that are arranged at intervals along the width direction YY′ of the battery charging case 1; the partition plate 411 is disposed of in one-to-one correspondence with multiple pairs of slots, and each partition plate 411 is clamped in the corresponding slot along both ends at the length direction XX′ of battery charging case 1. The partition plate 411 is designed to be detachably connected to the second bracket 213 through a snap-in connection, such that, on one hand, the partition plate 411 and the second bracket 213 are assembled and connected with ideal stability and, on the other hand, damaged partition plate 411 can be conveniently and effectively replaced.

In the second embodiment, the partition plate 411 is detachably connected to the second bracket 213 through screw connection and, for example, the two opposite ends of the second bracket 213 along the length direction XX′ of battery charging case 1 are provided with multiple pairs of threaded holes that are arranged at intervals along the width direction YY′ of battery charging case 1; the partition plate 411 is disposed in one-to-one correspondence with multiple pairs of threaded holes, and each partition plate 411 is, through corresponding screws, connected to the corresponding threaded holes at both ends along the length direction XX′ of battery charging case 1.

In the third embodiment, a plurality of partition plates are fixedly connected to the second bracket 213 through adhesive bonding.

Furthermore, as shown in FIGS. 1-4 and 6, the compartment body 211 is also provided with a waste discharging port 211b connected to the chamber of compartment body 211; the charging module 20 also includes a base 51 and a waste bin 52; the base 51 is embedded at the bottom of compartment body 211 and is detachably connected to the compartment body 211, and the base 51 has a discharging port that is connected to the first opening 213b of the second bracket and used for fully charged batteries to flow outside the chamber of compartment body 211; the waste bin 52 is used to store waste batteries, and the waste bin 52 is embedded in the chamber of compartment body 211 through a waste discharging port 211b and connected to the base 51. The waste bin 52 has a feeding port connected to the second opening 213c of the second bracket 213 and is used for waste batteries to flow into the chamber of waste bin 52. The waste bin 52 can perform concertina movement in a direction perpendicular to the plane of waste discharging port 211b, so that the waste bin 52 has a storage state in which it is retracted inside the chamber of compartment body 211 and an extended state in which it extends outside the chamber of compartment body 211.

The base 51 serves as the bracket for the charging module 20 and, for example, the outer contour shape of the base 51 can be, but is not limited to, rectangular or cylindrical and, for example, the preparation material of the base 51 can be, but is not limited to, plastic cement or one of the plastics.

The base 51 has a discharging port 22A; “the discharging port of the base 51a” can be understood as the opening of the base 51 outside the compartment body 211 for fully charged batteries to flow out of the chamber of compartment. The discharging port of the base 51a is connected to the first opening 213b of the second bracket 213, so that fully charged batteries can flow through the first opening 213b of the second bracket 213 and flow out from the discharging port of the base 51a to the outside of the chamber of compartment body 211.

The base 51 is embedded at the bottom of compartment body 211 and is detachably connected to the compartment body 211 and in other words, the compartment body 211 is located on the base 51 and is detachably connected to the base 51. The base 51 can be detachably connected to the compartment body 211 through, but is not limited to, at least one screw connection, snap-in connection, or plug-in connection.

As shown in FIGS. 1-4 and 6, waste bin 52 serves as a waste recycling station for charging module 20, used to accommodate waste batteries; for example, the outer contour shape of waste bin 52 can be, but is not limited to, rectangular or cylindrical; for example, the preparation material for waste bin 52 can be, but is not limited to, plastic cement or one of the plastics.

The feeding port of waste bin 52 is connected to the second opening 213c of the second bracket 213, so that waste batteries, such as batteries that do not meet model requirements and are not damaged, batteries that do not meet model requirements and are damaged, batteries that meet model requirements and are damaged, and so on, flow through the second opening 213c of the second bracket 213 and into the chamber of waste bin 52 from the feeding port of waste bin 52.

The waste bin 52 is embedded in the chamber of compartment body 211 through the waste discharging port 211b of compartment body 211 and is connected to the base 51, and the waste bin 52 can perform concertina movement in a direction perpendicular to the plane of waste discharging port 211b, so that the waste bin 52 has a folding state in which it is folded inside the chamber of compartment body 211 and an extended state in which it extends outside the chamber of compartment body 211.

The waste bin 52 can, perpendicular to the plane of the waste discharging port 211b of compartment body 211, move towards the direction close to the compartment body 211, so that the waste bin 52 moves relative to the base 51 to be folded in the chamber of compartment body 211 and is in the above-mentioned folding state. The waste bin 52 can accommodate waste batteries, such as batteries that do not meet model requirements and are not damaged, batteries that do not meet model requirements and are damaged, batteries that meet model requirements and are damaged, and so on. The waste bin 52 can move in a direction perpendicular to the plane where the waste discharging port 211b of compartment body 211 is located, away from the charging bin 21, so that the waste bin 52 moves relative to the base 51 to the chamber and extends outside of the compartment body 211 and is in the above-mentioned extended state, users then can, from the waste bin 52, take waste batteries such as batteries that do not meet model requirements and are not damaged, batteries that do not meet model requirements and are damaged, batteries that meet model requirements and are damaged, and so on.

A waste bin 52 is designed, the feeding port of waste bin 52 is connected to the second opening 213c of the second bracket 213, so that waste batteries such as those that do not meet model requirements and are not damaged, those that do not meet model requirements and are damaged, and those that meet model requirements and are damaged can flow into the chamber of waste bin 52 through the second opening 213c of the compartment body 211; the waste bin 52 can effectively accommodate waste batteries, so that waste batteries will not occupy the position of batteries that meet model requirements and are not damaged, and charging module 20 can normally charge batteries that meet model requirements and are not damaged. A base 51 is designed to carry the waste bin 52 and compartment body 211; Detachable connection is designed between the base 51 and the compartment body 211 of warehouse, and when the base 51 or compartment body 211 is damaged, only the damaged parts need to be replaced, resources are saved compared to the replacement of all. The waste bin 52 is designed to move relative to the base 51 and has a folding state in which it is folded inside the chamber of compartment body 211 and an extending state in which it is located outside the chamber of compartment body 211, and the waste bin 52 can switch between folding and extending states, making it easier for users to take waste batteries from the waste bin 52.

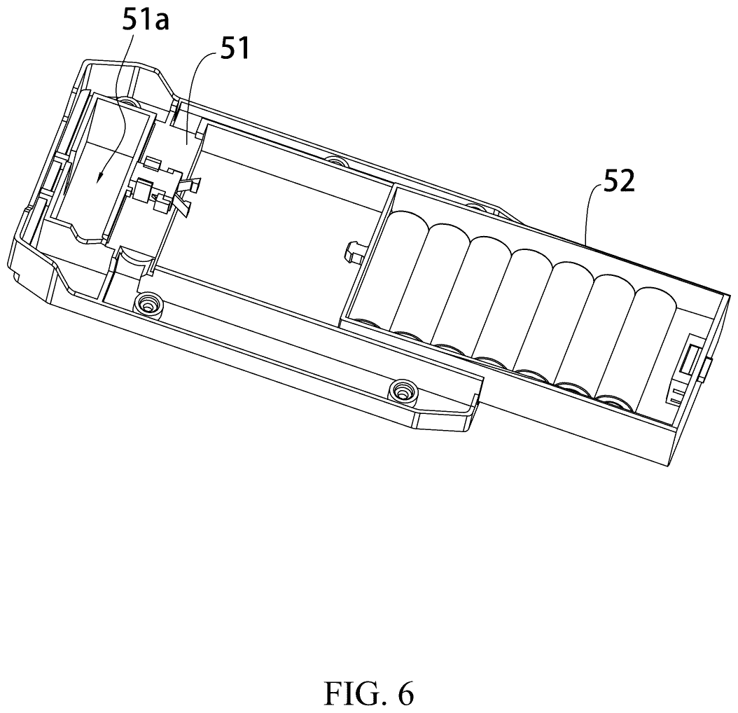

Furthermore, as shown in FIG. 6, the bottom of waste bin 52 has a guide surface 52c corresponding to the feeding port of waste bin 52, and from the side close to the discharging port 251 of base 51 to the side far away from the discharging port 251 of base 51, the distance between the guide surface 52nd and the flat surface of waste discharging port 211b of the compartment body 211 gradually decreases. A guide surface 52c that corresponds to the feeding port of waste bin 52 is designed at the bottom of waste bin 52, waste batteries such as the batteries that do not meet model requirements and are not damaged, those that do not meet model requirements and are damaged, and those that meet model requirements and are damaged, etc., flow through the second opening 213c of the second bracket 213 and into the chamber of waste bin 52 from the feeding port of waste bin 52, and finally directly fall onto the guide surface 52c. The guide surface 52c can guide waste batteries to roll towards the waste discharging port 211b of compartment body 211 in the waste bin 52 under the guidance of the guide surface 52c, such that it is easier for users to take out of waste bin 52 the batteries that do not meet model requirements and are not damaged, batteries that do not meet model requirements and are damaged, and the batteries that meet model requirements and are damaged.

Furthermore, as shown in FIG. 1, the base 51 is detachably connected to the compartment body 211 through screw and/or snap-in connections and, for example, the base 51 can be detachably connected to the compartment body 211 only through a screw connection and, for example, the base 51 can also be detachably connected to the compartment body 211 only through snap-in connection; for example, the base 51 can be detachably connected to the compartment body 211 through a screw connection or snap-in connection. The base 51 can be fixedly connected to the compartment body 211 through screws and threaded holes, and the base 51 can also be fixedly connected to the compartment body 211 through snap-in blocks and snap-in slots. Screw and/or snap-in connection is designed for the detachable connection between the base 51 and the compartment body 211, facilitating the installation and disassembly between the base 51 and the compartment body 211.

As shown in FIG. 7, in the second aspect, the embodiment of the present application provides a battery charging case 1; the battery charging case 1 comprises a feeding module 10, a discharging module 30, and the aforementioned charging module 20, and the feeding module 10 is used to accommodate the batteries to be charged, while the discharging module 30 is used to accommodate fully charged batteries; the discharging port of feeding compartment 11 of feeding module 10 is connected to the feeding port of compartment body 211, and the discharging port of charging module 20 (specifically the base 51 mentioned above) is connected to the feeding port of discharging compartment 31 of discharging module 30.

The battery charging case 1 in the embodiment of the present application has the above-mentioned charging module 20, and can automatically transfer fully charged batteries and waste batteries.

The above are only the preferred embodiments of the present application, and are not intended to limit the present application. Any modifications, equivalent substitutions, and improvements made within the spirit and principles of the present application shall be included within the scope of protection hereof.

What is claimed is:

1. A charging module, used for a battery charging case and used to charge a plurality of batteries to be charged, wherein the charging module comprises:
a charging compartment, comprising a compartment body and a second bracket, the second bracket is installed in a chamber of the compartment body and comprises a first discharging side and a second discharging side that are arranged along a width direction of the battery charging case; the first discharging side of the second bracket comprises a first opening for a plurality of fully charged batteries to flow through, and the second discharging side of the second bracket comprises a second opening for a plurality of waste batteries to flow through;
a transfer component, installed on the second bracket and located between the first discharging side of the second bracket and the second discharging side of the second bracket;
wherein the transfer component has a first transfer state and a second transfer state, and switches between the first and second transfer states, such that the plurality of fully charged batteries are transferred through the first opening in the first transfer state, and the plurality of waste batteries are transferred through the second opening in the second transfer state.

2. The charging module of claim 1, wherein the charging module further comprises a control component installed on the second bracket, the control component is electrically connected to the transfer component to control the transfer component to switch between the first transfer state and the second transfer state.

3. The charging module of claim 2, wherein the transfer component comprises:
a transfer frame body, installed on the second bracket and located between the first discharging side of the second bracket and the second discharging side of the second bracket;
a transfer unit, installed on the transfer frame body, and used to carry and transfer the plurality of fully charged batteries as well as waste batteries;
a fourth motor, installed on the second bracket and electrically connected to the control component, and a drive shaft of the fourth motor is connected to the transfer unit;
wherein in the first transfer state, the control component controls the fourth motor to drive the transfer unit to move, in order to transfer the plurality of fully charged batteries on the transfer unit to the first opening; in the second transfer state, the control component controls the fourth motor to drive the transfer unit to move, in order to transfer the plurality of waste batteries on the transfer unit to the second opening.

4. The charging module of claim 3, wherein the transfer unit comprises:
a driving pulley, installed on one end of the transfer frame body along the width direction of the battery charging case, and fixedly connected to the driving shaft of the fourth motor;
a driven pulley, installed on the other end of the transfer frame body along the width direction of the battery charging case;
a conveyor belt, drivingly connected to the driving pulley and the driven pulley, and used to carry the plurality of fully charged batteries and waste batteries.

5. The charging module of claim 1, wherein the charging module further comprises a limit component installed on the second bracket and provided near the first discharging side of the second bracket and the second discharging side of the second bracket; before the transfer component transfers the plurality of fully charged or waste batteries, the limit component is used to control the plurality of waste batteries to roll through the first opening, relative to the transfer component, towards the first discharging side of the second bracket, and the limit component is also used to control the plurality of fully charged batteries to roll through the first opening, relative to the transfer component, towards the second discharging side of the second bracket.

6. The charging module of claim 5, wherein the limit component comprises a limit element and a connector, the limit element is used to generate elastic deformation under external force, and is detachably connected to the second bracket through the connector.

7. The charging module of claim 1, wherein the charging module further comprises a partition component located on a feeding side of the second bracket and connected to the second bracket, and the partition component comprises a partition port corresponding to the transfer component, and the partition port has a size adapted to that of a fully charged battery.

8. The charging module of claim 7, wherein the partition component comprises a plurality of partition plates connected to the second bracket, and the plurality of partition plates are disposed at equal intervals along the width direction of the battery charging case, and a gap between adjacent two partition plates is used to form the partition port.

9. The charging module of claim 8, wherein the plurality of partition plates are detachably connected to the second bracket through a snap-in connection.

10. The charging module of claim 1, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

11. The charging module of claim 2, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

12. The charging module of claim 3, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

13. The charging module of claim 4, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

14. The charging module of claim 5, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

15. The charging module of claim 6, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

16. The charging module of claim 7, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

17. The charging module of claim 8, wherein the compartment body is also provided with a waste discharging port connected to the chamber of the compartment body; and the charging module further comprises:
a base, embedded at the bottom of the compartment body and detachably connected to the compartment body, and the base comprises a discharging port connected to the first opening and used for the plurality of fully charged batteries to flow outside the chamber of the compartment body;
a waste bin, used to store the plurality of waste batteries, and embedded in the chamber of the compartment body through the waste discharging port and connected to the base, the waste bin comprises a feeding port connected to the second opening and used for the plurality of waste batteries to flow into a chamber of the waste bin;
wherein the waste bin can perform concertina movement in a direction perpendicular to the plane of the waste discharging port so that the waste bin has a storage state in which it is retracted inside the chamber of the compartment body and an extended state in which it extends outside the chamber of the compartment body.

18. The charging module of claim 10, wherein the bottom of waste bin has a guide surface corresponding to the feeding port of the waste bin, and from the side close to the discharging port of the base to the side far away from the discharging port of base, the distance between the guide surface and the plane where the waste discharging port is located gradually decreases.

19. The charging module of claim 10, wherein the base is detachably connected to the compartment body through screw and/or snap-in connections.

20. A battery charging case, comprising:
a feeding module used to accommodate the batteries to be charged;
the charging module of claim 1;
a discharging module used to accommodate the fully charged batteries;
wherein a discharging port of the feeding module is connected to a feeding port of the compartment body, and a discharging port of the compartment body is connected to a feeding port of the discharging module.
